(19) United States
(12) Patent Application Publication
(10) Pub. No.: US 2007/0048697 A1
(43) Pub. Date: Mar. 1, 2007

(54) Interactive language learning techniques

(76) Inventors: Ping (Robert) Du, Shanghai (CN); Kan Liang, Shanghai (CN); Luhai Chen, Shanghai (CN)

Correspondence Address: KACVINSKY LLC;C/O INTELLEVATE, P.O. BOX 52050, MINNEAPOLIS, MN, 55402, US

(21) Appl. No.: 11/583,315

(22) Filed: Oct. 19, 2006

(30) Foreign Application Priority Data
May 27, 2005 (WO) PCT/CN05/00746
Jun. 24, 2005 (WO) PCT/CN05/00922

(51) Int. Cl. G09B 19/00

(52) U.S. Cl. 434/156

(57) ABSTRACT

Interactive language learning techniques may be described. An apparatus may comprise a remote control receiver to receive user commands, a receiver to receive voice information, and a virtual language tutor module. The virtual language tutor module may have a user interface module and a speech evaluation engine. The user interface module may respond to user commands to control the virtual language tutor module. The speech evaluation engine may analyze a speech characteristic of the voice information and provide feedback information for the speech characteristic. Other embodiments are described and claimed.

### RELATED APPLICATIONS

This application is a related to a commonly owned Patent Cooperation Treaty Patent Application Serial Number PCT/CN2005/000746 titled “A Homework Assignment And Assessment System For Spoken Language Education And Testing” and filed on May 27, 2005, and a commonly owned Patent Cooperation Treaty Patent Application Serial Number PCT/CN2005/000922 titled “Measurement and Presentation of Spoken Language Fluency” and filed on Jun. 24, 2005, which are both incorporated herein by reference.

### BACKGROUND

Computer Assisted Language Learning (CALL) has been developed to allow an automated system to record a spoken utterance and then make an assessment of pronunciation. CALL systems can then generate a Goodness of Pronunciation (GOP) score for presentation to the speaker or another party such as a teacher, supervisor, or guardian. In a language instruction context, an automated GOP score allows a student to practice speaking exercises and to be informed of improvement or regression. CALL systems typically use a benchmark of accurate pronunciation, based on a model speaker or some combination of model speakers and then compare the spoken utterance to the model.

Efforts have been directed toward generating and providing detailed information about the pronunciation assessment. In a pronunciation assessment, the utterance is divided into individual segments, such as words or phonemes. Each segment is assessed against the model. The student may then be informed that certain words or phonemes are mispronounced or inconsistently pronounced. This allows the student to focus attention on the areas that require the most improvement. In a sophisticated system, the automated system may provide information on how to improve pronunciation, such as by speaking higher or lower or by emphasizing a particular part of a phoneme.

Furthermore, learning a new language typically involves long hours of study, practice and repetition. Delivery systems for implementing CALL techniques have been typically limited to traditional computing environments, such as a personal computer. In some cases, however, it may not be convenient or comfortable to use a personal computer due to various resource constraints, such as display size, input devices, user interfaces, and so forth. Consequently, there may be a need for improved CALL systems and techniques to solve these and other problems.

### BRIEF DESCRIPTION OF THE DRAWINGS

FIG. 1 illustrates one embodiment of a media processing system.

FIG. 2 illustrates one embodiment of a media processing sub-system.

FIG. 3 illustrates one embodiment of an interactive language program.

FIG. 4 illustrates one embodiment of a remote control unit.

FIG. 5 illustrates one embodiment of an operation flow chart.

FIG. 6 illustrates one embodiment of a first user interface screen.

FIG. 7 illustrates one embodiment of a second user interface screen.

FIG. 8 illustrates one embodiment of a third user interface screen.

FIG. 9 illustrates one embodiment of a fourth user interface screen.

FIG. 10 illustrates one embodiment of user interface elements.

FIG. 11 illustrates one embodiment of a fifth user interface screen.

FIG. 12 illustrates one embodiment of a sixth user interface screen.

FIG. 13 illustrates one embodiment of a seventh user interface screen.

FIG. 14 illustrates one embodiment of an eighth user interface screen.

FIG. 15 illustrates one embodiment of a ninth user interface screen.

FIG. 16 illustrates one embodiment of a logic flow.

### DETAILED DESCRIPTION

Various embodiments may be directed to interactive language learning techniques in general. Some embodiments may be directed to CALL techniques to facilitate learning new languages. For example, a media processing system may be used to implement one or more CALL techniques to provide an interactive language learning platform to allow a user to learn a new language. To enhance learning, it may be desirable to receive an evaluation and corrective feedback regarding the quality of the spoken words in terms of pronunciation, intonation, fluency, and so forth. Some embodiments may use a virtual language tutor (VLT) for a CALL system to provide such corrective feedback. Furthermore, the VLT and CALL system may be implemented using a platform that is familiar to many users, such as a multimedia or home entertainment system. In one embodiment, for example, an interactive language learning console may be implemented as a digital set top box or other type of media processing system, with operations controlled by a general or specific remote control unit, and using a display device such as a television. The interactive language learning console may be used to execute an interactive learning program module that may use various CALL techniques to allow a user to learn a new language in the comfort of their home using the enhanced resources offered by a multimedia entertainment system.

In various embodiments, a user may use the remote control unit to choose and see or listen to the learning content, and practice via a wireless or wired microphone. The wireless microphone may be a handheld microphone, or in some cases, a head set for more comfortable operation. The interactive language learning console may use the interactive learning program module to evaluate the quality of a student's pronunciation, intonation and fluency, as well as provide constructive feedback information on how to improve such speech characteristics. In this manner, the student can entertain himself through the language learning process, walking freely in the living room, while enjoying the rich and robust visual and audio effects delivered by a television. In effect, every word and sentence practiced may be received, evaluated, analyzed, examined and diagnosed by the VLT.

In one embodiment, for example, an apparatus such as a media system may have an interactive language learning console. The interactive language learning console may include a remote control receiver to receive user commands, a wireless or wired receiver to receive voice information from a user, and a VLT module. The VLT module may include a user interface module and a speech evaluation engine. The user interface module may be arranged to respond to user commands to control and/or navigate the VLT module. The user commands may be communicated using a remote control unit, for example. The speech evaluation engine may be arranged to analyze one or more speech characteristics of the received voice information, and provide feedback information for the analyzed speech characteristics. Examples of speech characteristics may include, without limitation, pronunciation characteristics such as word scores or phoneme scores, intonation characteristics such as duration, stress and pitch, fluency characteristics such as speed and accuracy, and so forth. Other embodiments are described and claimed.

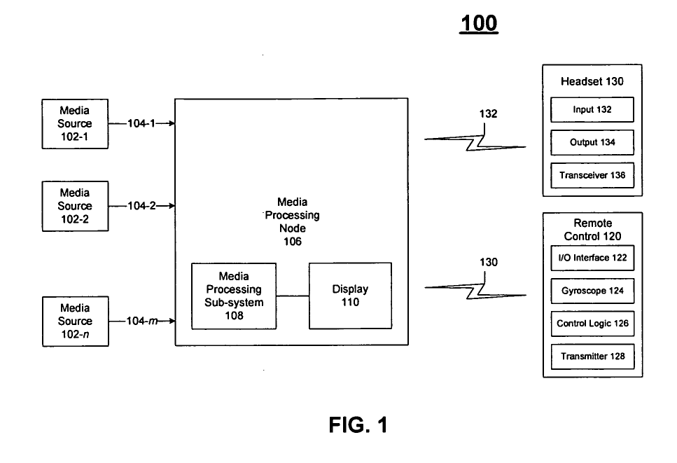

FIG. 1 illustrates one embodiment of a media processing system. FIG. 1 illustrates a block diagram of a media processing system 100. In one embodiment, for example, media processing system 100 may include multiple nodes. A node may comprise any physical or logical entity for processing and/or communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a television, a digital television, a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

In various embodiments, media processing system 100 may include one or more media source nodes 102-1-n. Media source nodes 102-1-n may comprise any media source capable of sourcing or delivering media information and/or control information to media processing node 106. More particularly, media source nodes 102-1-n may comprise any media source capable of sourcing or delivering digital audio and/or video (A/V) signals representing media content such as language content to media processing node 106 via wired or wireless connections 104-1-m. Examples of language content may include any media content as previously described as generally or specifically directed to language information suitable for CALL systems. Examples of media source nodes 102-1-n may include any hardware or software element capable of storing and/or delivering media information, such as a DVD device, a VHS device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, television system, digital television system, set top boxes, digital set top boxes, personal video recorders, digital video recorders, server systems, server farms, storage area networks, network appliances, computer systems, personal computer systems, digital audio devices (e.g., MP3 players), and so forth. Other examples of media source nodes 102-1-n may include media distribution systems to provide broadcast or streaming analog or digital AV signals to media processing node 106. Examples of media distribution systems may include, for example, Over The Air (OTA) broadcast systems, terrestrial cable systems (CATV), satellite broadcast systems, and so forth. It is worthy to note that media source nodes 102-1-n may be internal or external to media processing node 106, depending upon a given implementation. The embodiments are not limited in this context.

In one embodiment, for example, media source node 102-1 may comprise a CD or DVD recorder and/or playback device. Media source node 102-2 may comprise a VLT online server that may be accessed via a web browser or a VLT module implemented as part of media processing node 106. The VLT online server may be arranged to interoperate with the VLT module of media processing node 106. The VLT online server may include media content such as language content, as well as various backend applications to support the VLT module. The VLT online server may also allow an instructor or teacher to provide homework and assignments, study courses, feedback information, grading, benchmark A/V information such as benchmark voice information, and so forth.

In various embodiments, media processing system 100 may comprise a media processing node 106 to connect to media source nodes 102-1-n over one or more communications media 104-1-m. Media processing node 106 may comprise any node as previously described with reference to media source nodes 102-1-n that is arranged to process media information received from media source nodes 102-1-n. In various embodiments, media processing node 106 may comprise, or be implemented as, one or more media processing devices having a processing system, a processing sub-system, a processor, a computer, a device, a workstation, a server, a media server, a digital set top box, a cable receiver, a satellite receiver, a multimedia entertainment system, or any other processing architecture. The embodiments are not limited in this context.

In various embodiments, media processing node 106 may include a media processing sub-system 108. Media processing sub-system 108 may comprise a processor, memory, and application hardware and/or software arranged to process media information received from media source nodes 102-1-n. For example, media processing sub-system 108 may be arranged to perform various media operations and user interface operations as described in more detail below. Media processing sub-system 108 may output the processed media information to a display 110. The embodiments are not limited in this context.

In various embodiments, media processing node 106 may include a display 110. Display 110 may be any display capable of displaying media information received from media source nodes 102-1-n. Display 110 may display the media information at a given format resolution. In various embodiments, for example, the incoming video signals received from media source nodes 102-1-n may have a native format, sometimes referred to as a visual resolution format. Examples of a visual resolution format include a digital television (DTV) format, high definition television (HDTV), progressive format, computer display formats, and so forth. For example, the media information may be encoded with a vertical resolution format ranging between 480 visible lines per frame to 1080 visible lines per frame, and a horizontal resolution format ranging between 640 visible pixels per line to 1920 visible pixels per line. In one embodiment, for example, the media information may be encoded in an HDTV video signal having a visual resolution format of 720 progressive (720 p), which refers to 720 vertical pixels and 1280 horizontal pixels (720×1280). In another example, the media information may have a visual resolution format corresponding to various computer display formats, such as a video graphics array (VGA) format resolution (640×480), a super VGA (SVGA) format resolution (800×600), an extended graphics array (XGA) format resolution (1024×768), a super XGA (SXGA) format resolution (1280×1024), an ultra XGA (UXGA) format resolution (1600×1200), and so forth. The embodiments are not limited in this context. The type of displays and format resolutions may vary in accordance with a given set of design or performance constraints, and the embodiments are not limited in this context.

In various embodiments, media processing system 100 may be used to implement one or more CALL techniques to provide an interactive language learning platform to allow a user to learn a new language. To enhance learning, it may be desirable to receive corrective feedback regarding the quality of the spoken words in terms of various speech characteristics, such as pronunciation, intonation, fluency, and so forth. This may be accomplished using a platform that is familiar to many users, such as a home entertainment system. In one embodiment, for example, media processing node 106 may comprise an interactive language learning console or CALL system implemented as a digital set top box for media processing system 100, operated by a general or specific remote control unit 120, with voice information from a user provided by headset 130, and with display 110 comprising a television. The interactive language learning console may be used to execute an interactive learning program module that may use various CALL techniques to allow a user to learn a new language in the comfort of their home.

A user may use the remote control unit 120 to choose and see or listen to the learning content, and practice via a wireless headset 130. Wireless headset 130 may comprise one or more input devices 132, such as a microphone, for example. Wireless headset 130 may also comprise one or more output devices 134, such as audio speakers, for example. Wireless headset 130 may communicate media information such as voice information via a wireless transceiver 136 to a matching transceiver implemented as part of media processing node 106 over wireless communications media 132. In alternative embodiments, voice information may be captured using a wired or wireless microphone (e.g., handheld or through a separate device), and reproduced or played back through speakers implemented with display 110 (e.g., a television) or external speakers connected to display 110 (e.g., stereo system) or media processing node 106. The embodiments are not limited in this context.

To facilitate operations, media processing sub-system 108 may include a user interface module. In various embodiments, the user interface module may allow a user to control certain operations of media processing node 106, such as various system programs or application programs. In one embodiment, for example, the user interface module may be used to control or manage a CALL application, such as an interactive language program. The user interface module may display various user options to a viewer on display 110 in the form of a GUI, for example. In such cases, remote control unit 120 may be used to navigate through the various options.

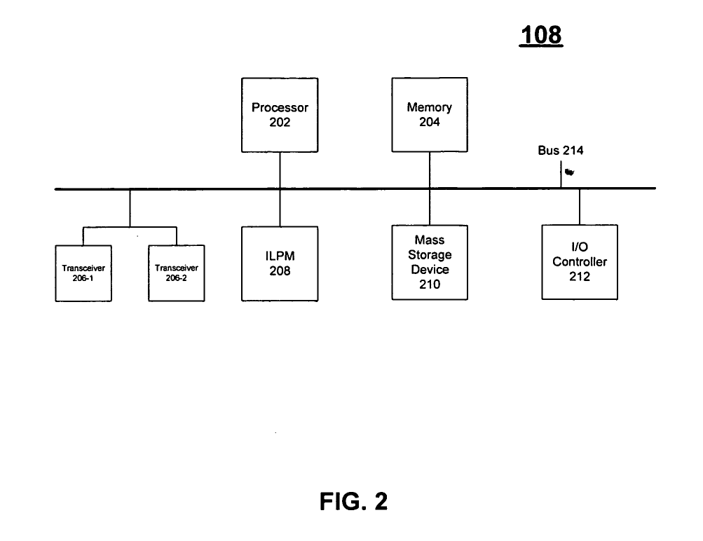

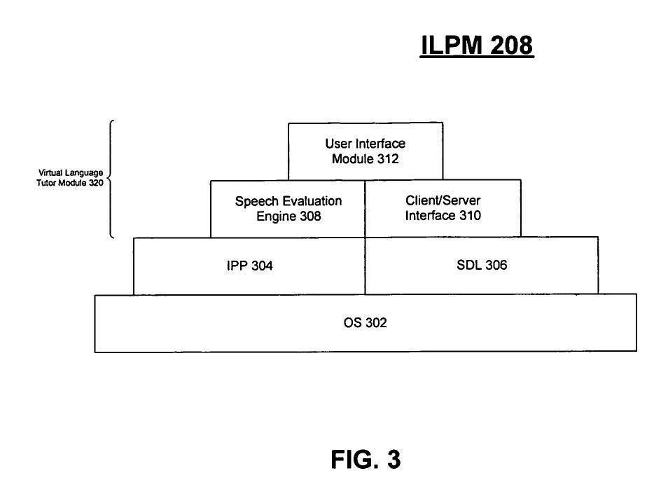

In various embodiments, a user interface module (e.g., user interface module 312 as shown in FIG. 3) of media processing sub-system 108 may be arranged to accept user input from a remote control unit 120. Remote control unit 120 may be arranged to control, manage or operate media processing node 106 and/or any application programs residing thereon (e.g., an interactive language learning application program) by communicating control information using infrared (IR) or radio-frequency (RF) signals via transmitter 128 over wireless communications media 130. In one embodiment, for example, remote control unit 120 may include one or more light-emitting diodes (LED) to generate the infrared signals. The carrier frequency and data rate of such infrared signals may vary according to a given implementation. An infrared remote control may typically send the control information in a low-speed burst, typically for distances of approximately 30 feet or more. In another embodiment, for example, remote control unit 120 may include an RF transceiver (e.g., transmitter 128). The RF transceiver may match the RF transceiver used by media processing sub-system 108, as discussed in more detail with reference to FIG. 2. An RF remote control typically has a greater distance than an IR remote control, and may also have the added benefits of greater bandwidth and removing the need for line-of-sight operations. For example, an RF remote control may be used to access devices behind objects such as cabinet doors.

Remote control unit 120 may control operations for media processing node 106 by communicating control information to media processing node 106. The control information may include one or more IR or RF remote control command codes (“command codes”) corresponding to various operations that the device is capable of performing. The command codes may be assigned to one or more keys or buttons included with an I/O device 122 for remote control unit 120. I/O device 122 of remote control unit 120 may comprise various hardware or software buttons, switches, controls or toggles to accept user commands. For example, I/O device 122 may include a numeric keypad, arrow buttons, selection buttons, power buttons, mode buttons, selection buttons, menu buttons, and other controls needed to perform the normal control operations typically found in conventional remote controls. There are many different types of coding systems and command codes, and generally different manufacturers may use different command codes for controlling a given device.

In addition to I/O device 122, remote control unit 120 may also include elements that allow a user to enter information into a user interface at a distance by moving the remote control through the air in two or three dimensional space. For example, remote control unit 120 may include a gyroscope 124 and control logic 126. Gyroscope 124 may comprise a gyroscope typically used for pointing devices, remote controls and game controllers. For example, gyroscope 124 may comprise a miniature optical spin gyroscope. Gyroscope 124 may be an inertial sensor arranged to detect natural hand motions to move a cursor or graphic on display 110, such as a television screen or computer monitor. Gyroscope 124 and control logic 126 may be components for an “In Air” motion-sensing technology that can measure the angle and speed of deviation to move a cursor or other indicator between Point A and Point B, allowing users to select content or enable features on a device waving or pointing remote control unit 120 in the air. In this arrangement, remote control unit 120 may be used for various applications, to include providing device control, content indexing, computer pointers, game controllers, content navigation and distribution to fixed and mobile components through a single, hand-held user interface device.

Although some embodiments are described with remote control unit 120 using a gyroscope 124 by way of example, it may be appreciated that other free-space pointing devices may also be used with remote control unit 120 or in lieu of remote control unit 120. For example, some embodiments may use a free-space pointing device made by Hillcrest Labs™ for use with the Welcome HoME™ system, a media center remote control such as WavIt MC™ made by ThinkOptics, Inc., a game controller such as WavIt XT™ made by ThinkOptics, Inc., a business presenter such as WavIt XB™ made by ThinkOptics, Inc., free-space pointing devices using accelerometers, and so forth. The embodiments are not limited in this context.

In one embodiment, for example, gyroscope 124 and control logic 126 may be implemented using the MG101 and accompanying software and controllers as made by Thomson's Gyration, Inc., Saratoga, Calif. The MG1101 is a dual-axis miniature rate gyroscope that is self-contained for integration into human input devices such as remote control unit 120. The MG1101 has a tri-axial vibratory structure that isolates the vibrating elements to decrease potential drift and improve shock resistance. The MG1101 can be mounted directly to a printed circuit board without additional shock mounting. The MG1101 uses an electromagnetic transducer design and a single etched beam structure that utilizes the “Coriolis Effect” to sense rotation in two axes simultaneously. The MG1101 includes an integrated analog-to-digital converter (ADC) and communicates via a conventional 2-wire serial interface bus allowing the MG1101 to connect directly to a microcontroller with no additional hardware. The MG1101 further includes memory, such as 1K of available EEPROM storage on board, for example. Although the MG1101 is provided by way of example, other gyroscope technology may be implemented for gyroscope 124 and control logic 126 as desired for a given implementation. The embodiments are not limited in this context.

In operation, a user may use remote control unit 120 to provide information for the user interface module at a distance by moving remote control unit 120 through the air, similar to an air mouse. For example, a user may point remote control unit 120 to various objects displayed on display 110. Gyroscope 124 may sense the movements of remote control unit 120, and send movement information representing the movements to media processing node 106 over wireless communications media 130. The user interface module of media processing sub-system 108 may receive the movement information, and move a pointer (e.g., mouse pointer) or cursor in accordance with the movement information on display 110. The user interface module may use the movement information and associated selection commands to perform any number of user defined operations for media source nodes 102-1-n and/or media source node 106, such as navigating a VLT module, selecting options, traversing menus, switching user interface screens, and so forth.

In addition to operating as an air mouse or pointing device using gyroscope 124 and control logic 126, remote control unit 120 may use other techniques to control a pointer. For example, remote control unit 120 may include an integrated pointing device. The pointing device may include various types of pointer controls, such as a track or roller ball, a pointing stick or nub, a joystick, arrow keys, direction keys, and so forth. Integrating a pointing device with remote control unit 120 may facilitate pointing operations for a user. Alternatively, a user may use a pointing device separate from remote control unit 120, such as various different types of mice or controllers. The pointing device may also be part of another device other than remote control unit 120, such as a wired or wireless keyboard. The particular implementation for the pointing device may vary as long as the pointing device provides movement information for the user interface module and allows a user to generate the movement information from a distance (e.g., normal viewing distance). The embodiments are not limited in this context.

In general operation, a student may use the remote control unit 120 and wireless headset 130 to interact and communicate information with media processing node 106. Media processing sub-system 108 of media processing node 106 may be arranged to implement control logic in the form of software elements, hardware elements, or a combination of both, for an interactive language program module (ILPM) that may be used to implement various CALL techniques. The ILPM may include various software components, including a VLT module 320. Media processing sub-system 108 in general, and an ILPM suitable for execution by media processing sub-system 108 in particular, may be described in more detail with reference to FIG. 2

FIG. 2 illustrates one embodiment of a media processing sub-system 108. FIG. 2 illustrates a block diagram of a media processing sub-system 108 suitable for use with media processing node 106 as described with reference to FIG. 1. The embodiments are not limited, however, to the example given in FIG. 2.

As shown in FIG. 2, media processing sub-system 108 may comprise multiple elements. One or more elements may be implemented using one or more circuits, components, registers, processors, software subroutines, modules, or any combination thereof, as desired for a given set of design or performance constraints. Although FIG. 2 shows a limited number of elements in a certain topology by way of example, it can be appreciated that more or less elements in any suitable topology may be used in media processing sub-system 108 as desired for a given implementation. The embodiments are not limited in this context.

In various embodiments, media processing sub-system 108 may include a processor 202. Processor 202 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 202 may be implemented as a general purpose processor, such as a processor made by Intel® Corporation, Santa Clara, Calif. Processor 202 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. In one embodiment, for example, processor 202 may comprise an Ultra Low Voltage Celeron® M Processor implemented on an Intel® 854 chipset based board as made by Intel Corporation, Santa Clara, Calif. This may comprise a relatively low power and fan-free solution for the application of a consumer electronics device such as an interactive language learning console of media processing node 106. The embodiments are not limited in this context.

In one embodiment, media processing sub-system 108 may include a memory 204 to couple to processor 202. Memory 204 may be coupled to processor 202 via communications bus 214, or by a dedicated communications bus between processor 202 and memory 204, as desired for a given implementation. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 204 may be included on the same integrated circuit as processor 202, or alternatively some portion or all of memory 204 may be disposed on an integrated circuit or other medium, for example a hard disk drive, that is external to the integrated circuit of processor 202. The embodiments are not limited in this context.

In various embodiments, media processing sub-system 108 may include various transceivers 206-1-p. Transceivers 206-1-p may comprise any infrared or radio transmitter and/or receiver arranged to operate in accordance with a desired set of wireless protocols. Examples of suitable wireless protocols may include various wireless local area network (WLAN) or wireless wide area network (WWAN) protocols, including the Institute of Electrical and Electronics Engineers (IEEE) 802.xx series of protocols, such as IEEE 802.11a/b/g/n, IEEE 802.16, IEEE 802.20, and so forth. Other examples of WWAN protocols may include cellular-based protocols, such as Global System for Mobile Communications (GSM) cellular radiotelephone system protocols with General Packet Radio Service (GPRS), Code Division Multiple Access (CDMA) cellular radiotelephone communication systems with 1xRTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context.

In one embodiment, media processing sub-system 108 may include at least two transceivers 206-1, 206-2. Transceiver 206-1 may comprise a remote control receiver arranged to communicate with remote control unit 120 via transmitter 128. Transceiver 206-1 may receive, for example, control information to navigate an ILPM for media processing node 106. Transceiver 206-2 may comprise a wireless receiver arranged to communicate with wireless headset 130 via transceiver 134. It may be appreciated that transceivers 206-1, 206-2 are merely examples, and more or less transceivers may be used with media processing sub-system 108 and still fall within the scope of the embodiments. The embodiments are not limited in this context.

In various embodiments, media processing sub-system 108 may include one or more modules. The modules may comprise, or be implemented as, one or more systems, sub-systems, processors, devices, machines, tools, components, circuits, registers, applications, programs, subroutines, or any combination thereof, as desired for a given set of design or performance constraints. The embodiments are not limited in this context.

In various embodiments, media processing sub-system 108 may include a MSD 210. Examples of MSD 210 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, media processing sub-system 108 may include one or more I/O adapters 212. Examples of I/O adapters 212 may include Universal Serial Bus (USB) ports/adapters, IEEE 1394 Firewire ports/adapters, and so forth. The embodiments are not limited in this context.

In one embodiment, for example, media processing sub-system 108 may include various application programs, such as an ILPM 208. For example, ILPM 208 may comprise a GUI to communicate information between a user and media processing sub-system 108. Media processing sub-system 108 may also include system programs. System programs assists in the running of a computer system. System programs may be directly responsible for controlling, integrating, and managing the individual hardware components of the computer system. Examples of system programs may include operating systems (OS), device drivers, programming tools, utility programs, software libraries, interfaces, program interfaces, API, and so forth. It may be appreciated that ILPM 208 may be implemented as software executed by processor 202, dedicated hardware such as a media processor or circuit, or a combination of both. The embodiments are not limited in this context.

In various embodiments, ILPM 208 may be arranged to receive user input via remote control unit 120. Remote control unit 120 may be arranged to allow a user to control, navigate, or otherwise manage the language content and lessons provided by ILPM 208. Transceiver 206-1 may receive user commands such as user commands or movement information from remote control unit 120, and move a pointer or cursor in response to the user commands or movement information on display 110. Various components of ILPM 208 may be further described with reference to FIG. 3.

FIG. 3 illustrates one embodiment of an ILPM. FIG. 3 illustrates a more detailed block diagram for ILPM 208. In one embodiment, for example, the software elements for ILPM 208 may comprise a three layer stack, including a system layer, middleware layer and application layer. The system layer may comprise a general or tailored OS 302 for the interactive language learning console. In one embodiment, for example, OS 302 may comprise a tailored embedded Linux OS requiring less than 10 MB of memory, and OS 302 and other application programs can be therefore be stored on 64M DOM (e.g., flash memory with IDE interface). The middleware layer may include a library of Intel Integrated Performance Primitives (IPP) 304 and a library of Simple Direct Media Layer (SDL) 306, where IPP 304 may be used for media encoding/decoding development or implementation (e.g., speech, voice, audio, video, images, and so forth), and SDL 306 may be used for GUI development or implementation.

In various embodiments, the application layer may include various software components for a CALL system, such as VLT module 320. VLT module 320 parses and analyzes voice information received from a user via headset 130, compares the voice information from a user with benchmark voice information, and provides an evaluation of the user's speaking pronunciation, intonation, and fluency over words, sentences or paragraphs based on metrics for accuracy and speed. In one embodiment, for example, VLT module 320 may comprise, for example, a speech evaluation engine 308, a communication interface 310, and a user interface module 312. It may be appreciated that VLT module 320 may comprise more or less software components as desired for a given implementation.

In one embodiment, for example, VLT module 320 may include user interface module 312. User interface module 312 may be arranged to provide various GUI screens for features or options offered by VLT module 320. User interface module 312 may respond to user commands or movement information received from remote control unit 120 that are designed to control various elements of VLT module 320.

In one embodiment, for example, VLT module 320 may include speech evaluation engine 308. Virtual language tutor module 320 may display language content on display device 110 via user interface module 312. For example, user interface module 312 may display language content in the form of text for a given language. A user may read the text and attempt to speak or reproduce the text orally. The speech or spoken words may be captured by microphone 132, and transmitted to transceiver 206-2 via transceiver 134 of headset 130. Speech evaluation engine 308 may be arranged to analyze one or more speech characteristics of the voice information received from headset 130, and provide feedback information for the analyzed speech characteristic. To accomplish this, speech evaluation engine 308 may parse the received voice information into discrete speech segments or chunks of varying levels of granularity in order to identify phonemes, speech utterances, letters, sounds, words, sentences, paragraphs, and so forth, from the voice information. Speech evaluation engine 308 may accomplish this using, for example, various speech recognition techniques.

Speech evaluation engine 308 may analyze various speech characteristics of the parsed voice information. For example, speech evaluation engine 308 may analyze pronunciation of a given speech segment from the voice information, and provide feedback information regarding the quality of the pronunciation. Threshold comparison values or benchmark voice information representing proper pronunciation levels may be set for various pronunciation aspects of a language, and feedback information in the form of word scores or phoneme scores may be displayed on display device 110 for the user. In another example, speech evaluation engine 308 may analyze intonation for a given speech segment from the voice information, and provide feedback information regarding the quality of the intonation. Threshold comparison values or benchmark voice information representing proper intonation levels may be set for various intonation aspects of a language, and feedback information in the form of duration values, stress values, or pitch values may be displayed on display device 110 for the user. It may be appreciated that the speech characteristics of pronunciation and intonation and corresponding quality metrics are merely examples, and any number of speech characteristics and quality metrics may be implemented for speech evaluation engine 308 as desired for a given set of performance or design constraints. The embodiments are not limited in this context.

In one embodiment, for example, speech evaluation engine 308 may be arranged to focus on pronunciation, vocabulary and accuracy of the spoken utterance. The evaluation provided to the student may include accuracy of pronunciation and perhaps intonation of particular sentences, words or phonemes in a passage. In addition, speech evaluation engine 308 may be arranged to measure performance that would be obtained in real language speaking situations. Real speaking situations are when a speaker may need to form ideas, determine how to best express those ideas and consider what others are saying all under time pressure or other stress.

In one embodiment, for example, speech evaluation engine 308 may be arranged to measure a fluency parameter. Fluency may be evaluated by measuring not only accuracy but also speed. A speaker that is comfortable speaking at normal speeds for the language may be better able to communicate in real speaking situations. Consequently, adding a speed measurement to the quality measurement makes the fluency assessment more holistic and better reflects a speaker's ability to use learned language skills in a real speaking environment. It may be possible for a student to meet all the pronunciation, intonation and other benchmarks of a CALL system or other language tool simply by slowing down. If the student cannot accurately pronounce a passage at normal speaking speed, however, the student may still not be comprehensible to others. In addition, slow speech may reflect a slower ability to form sounds or even form thoughts and sentences in the language.

The fluency (Fᵤₛₑᵣ) of an utterance of a user or student may be compared to a benchmark utterance as shown in the following example Equation (1) as follows:
Fᵤₛₑᵣ=(Aᵤₛₑᵣ/A_{ben})(D_{ben}/Dᵤₛₑᵣ) 100% Equation (1)
In this equation Fᵤₛₑᵣ represents a score for the fluency of an utterance of a user. Aᵤₛₑᵣ and A_{ben} represent the accuracy of the user's utterance and the accuracy of a benchmark utterance. The benchmark is the standard against which the user or student is to be measured. The accuracy values may be numbers determined based on pronunciation or intonation or both and may be determined in any of a variety of different ways. The ratio (Aᵤₛₑᵣ/A_{ben}) provides an indication of how closely the user's utterance matches that of the benchmark. The variables D_{ben} and Dᵤₛₑᵣ represent the duration of the benchmark and the duration of the utterance, respectively. In one example, the utterance is a sentence or passage and native speakers are asked to read it at a relaxed pace. The time that it takes one or more native speakers to read the passage in seconds is taken as the benchmark duration for the utterance. When the user speaks the passage the time that the user takes to speak the passage is also measured and this is used as the duration for the user. The ratio provides a measure of how close the user has come to the benchmark speed. By multiplying accuracy and duration together as shown in Equation (1), the fluency score can reflect achievement in both areas. While the two scores are being shown as multiplied together, they may be combined in other ways.

The fluency score is shown as being factored by 100%. This allows the student to see the fluency score as a percentage. Accordingly, a perfect score would show as 100%. However, other scales may be used. A score may be presented as value between 1 and 10 or any other number. The Fluency score may alternatively be presented as a raw unscaled score.

The fluency score may be calculated in a variety of different ways. As an alternative to Equation (1), the benchmark values may be consolidated. If the benchmarks for any particular utterance are a constant, then A_{ben} and D_{ben} may be reduced to a factor and this factor may be scaled on the percent or any other scale to produce a constant n. The fluency score may then be determined as shown in Equation (2), as follows:
Fᵤₛₑᵣ=(Aᵤₛₑᵣ/Dᵤₛₑᵣ)n% Equation (2)
As suggested by Equation (2), the user's fluency may be scored as the accuracy of the utterance divided by the amount of time used to speak the utterance. In other words it is the accuracy score per unit time.

Either or both ratios may be weighted to reflect a greater or lesser importance as shown in Equation (3), as follows:
Fᵤₛₑᵣ=(aAᵤₛₑᵣ/bDᵤₛₑᵣ)n% Equation (3)
In Equation (3), a is a weight or weighting factor that is applied to adjust the significance of the user's accuracy in the final score and b is a weighting factor to adjust the significance of the user's speed in the final fluency score. Weights may be applied to the two ratios in Equation (1) in a similar way. The weighting factors may be changed depending on the utterance, the assignment, or the level of proficiency in the language. For example, for a beginning student, it may be more important to stress accuracy in producing the sounds of the language. For an advanced student, it may be more important to stress normal speaking tempos.

To perform an oral homework assignment, such as oral practice, the student may be requested to first listen to the audio portion of a benchmark voice pronunciation and intonation of a sentence by playing a benchmark A/V (e.g., benchmark voice information). In one embodiment, VLT module 320 plays one sentence of the benchmark A/V at a time when the student presses a play button. The student also may have an option of repeating a sentence or moving to the next sentence by pressing a forward or reverse button, respectively. The benchmark voice information may include a spoken expression or a visual component only. For example, the benchmark voice information may have only an audio recitation of a benchmark expression. Alternatively, the audio may be accompanied by a visualization of a person speaking the expression or other visual cues related to the passage.

Alternatively, instead of listening to a sentence or passage, the student may be requested to read a passage. The sentence, expression, or passage may be displayed on a screen or VLT module 320 may refer the student to other reference materials. Further alternatives are also possible, for example, the student may be requested to compose an answer or a response to a question or other prompt. The benchmark voice information may, for example, provide an image of an object or action to prompt the student to name the object or action.

After listening to a sentence or receiving some other A/V cue, the student may respond by pressing a record button and orally repeating the sentence back to VLT module 320. VLT module 320 may record the student's pronunciation of the sentence, separate the student's recorded sentence, word by word, and phoneme by phoneme, and perform any other appropriate operations on the recorded utterance.

Speech evaluation engine 308 of VLT module 320 may then analyze the student's accuracy, by assessing for example the pronunciation and intonation of each word or phoneme by comparing it with the pronunciation and intonation of the benchmark voice information or in some other way. This may be accomplished in any of a variety of different ways including using forced alignment, speech analysis, and pattern recognition techniques. Speech evaluation engine 308 may also analyze the student's speed by measuring the elapsed time or duration of the recorded utterance and comparing it to the duration of the benchmark voice. The speed measurement may be determined on a per word, per sentence, per passage or total utterance basis. Alternatively, one or more of these speed measures may be combined. The accuracy and speed may then be combined into a fluency score using, for example, any one or more of Equations (1), (2) or (3) as previously described.

After comparing the student's response with the benchmark voice, VLT module 320 provides feedback information and grading to the student. The feedback information and grading may provide the student with detailed information regarding both accuracy and speed, which may aid the student in knowing which sentence, word or phoneme needs improvement.

The fluency of a spoken utterance may be measured when a student speaks into an input 132 (e.g., a microphone) of wireless headset 130. The utterance may be captured as audio, and the accuracy and speed of the utterance may be analyzed using the captured audio. If the student speaks a known text or passage, then the captured audio may be analyzed against a benchmark for the known text. The fluency analysis may then be provided to the student.

In one embodiment, for example, VLT module 320 may include communication interface 312. Virtual language tutor module 320 may be implemented as a client/server based spoken language drilling solution, where users log on to the client device (e.g., interactive language learning console) to practice the language content in the content pool or the task assigned by a teacher. The language content in the content pool may be derived, for example, from one or more media source nodes 102-1-n, such as an offline CD/DVD or an online VLT server. In the latter case, the online VLT server provides functionality such as student information management, student community statistics, homework management by teacher and update by administrator, and so forth. An automatic content creation tool may be used to support and manage content management operations. The automatic content creation tool can be used to import any existing media file and its transcription into any VLT content source. The language content may then be published on the online VLT server, or distributed via a DVD or CD.

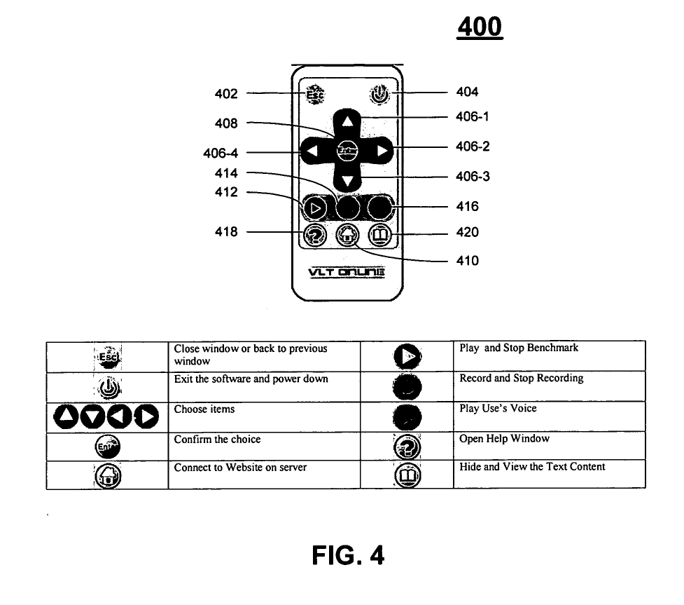

FIG. 4 illustrates one embodiment of a remote control unit. FIG. 4 illustrates a remote control unit 400. Remote control unit 400 may be representative of, for example, remote control unit 120 as described with reference to FIG. 1. More particularly, remote control unit 400 may include all the elements of remote control unit 120, and further, provide one embodiment of a control interface suitable for use with controlling and interacting with VLT module 320. As shown in FIG. 4, remote control unit 400 may comprise a layout of input keys that include an escape key 402 that may be used to close a window for user interface module 312 or move back to a previous window, a power key 404 to exit VLT module 320 and power down media processing node 106, direction keys 406-1-4 to control a cursor or pointer on a user interface screen provided by user interface module 312 on display 110, an enter key 408 to select or confirm a choice, an online key 410 to connect to a media source node 104 such as a website or server, a play benchmark key 412 to play and stop a benchmark audio file, a record key 414 to record voice information and stop recording voice information, a play voice key 416 to play or reproduce recorded voice information from an instructor or user, a help key 418 to open a help window 1400, and a content key 420 to hide and view the text content. The input keys and layout for remote control unit 400 are provided by way of example and not limitation. Any number of input keys in various layouts may be used and still fall within the scope of the embodiments.

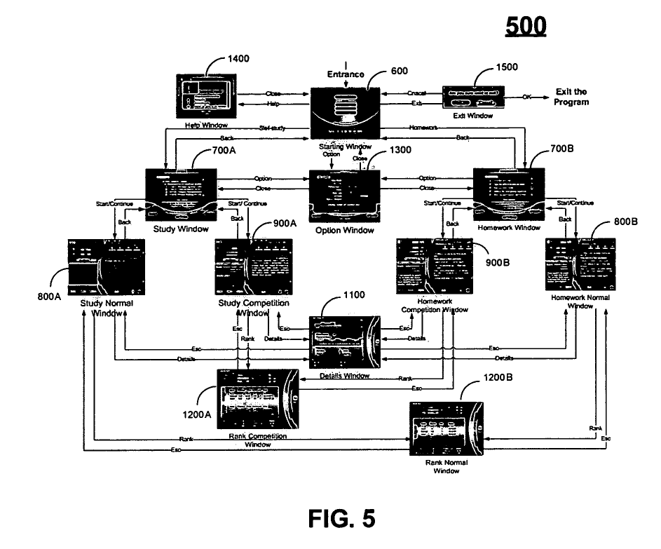

In operation, remote control unit 400 may be used to provide input keys to receive user commands to control and navigate through the various user interface screens and options provided by user interface module 312 of VLT module 320. It is worthy to note that in some cases the options and features provided by a given user interface screen may be activated using one or more input keys of remote control unit 400, and/or one or more graphic buttons embedded within the user interface screen. Furthermore, in some cases the input keys of remote control unit 400 may match a corresponding graphic button having a similar symbol or icon as the input keys, in which case both the input keys and graphic buttons will activate the same functions. In other cases, however, the input keys of remote control unit 400 may not match a corresponding graphic button with a similar symbol or icon as the input keys, and yet both the input keys and graphic buttons may perform the same function. In addition, the input keys of remote control unit 400 may not match a corresponding graphic button with a similar symbol or icon as the input keys, and the input keys and graphic buttons may perform different functions. Finally, the function activated by a given input keys of remote control unit 400 may change based on a given user interface screen displayed by display 110 at the moment in time the input key is depressed. As a result, examples of functions assigned to a given input key or graphic button as described herein may apply to a specific usage case but not necessarily all usage cases. Examples of the various user interface screens and related user commands may be described with reference to FIG. 5.

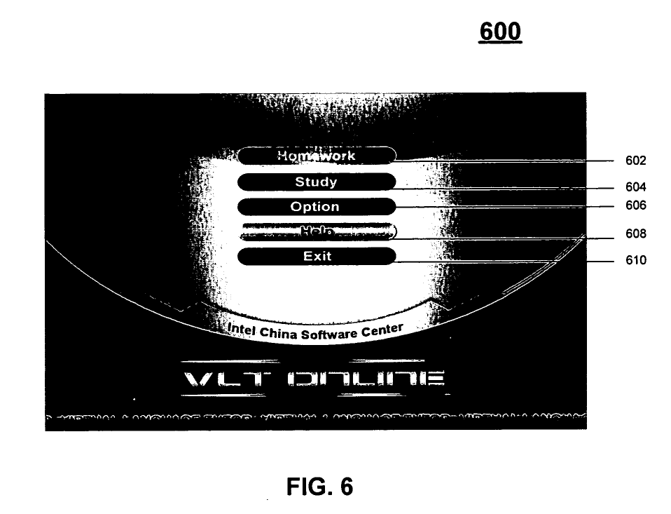

FIG. 5 illustrates one embodiment of an operation flow chart. FIG. 5 illustrates an operation flow chart 500. Operation flow chart 500 illustrates examples of various user interface screens provided by user interface module 312 of VLT module 320, and the operational flow between the user interface screens. As shown in FIG. 5, for example, entrance to VLT module 320 may begin with a user interface screen 600 of a starting window. The starting window may be switched to various other user interface screens, such as a user interface screen 1400 of a help window, a user interface screen 1500 of an exit message window, a user interface screen 700A of a study window, a user interface screen 700B of a homework window, and a user interface screen 1300 of an option window. User interface screen 700A may be switched to a user interface screen 800A of a study normal window, and a user interface screen 900A of a study competition window. User interface screen 700B may be switched to user interface screen 800B of a homework & normal window and user interface screen 900B of a homework & competition window. A user interface screen 1100 of a details window may be accessed via screens 800A, 800B and screens 900A, 900B. A user interface screen 1200A of a competition rank window may be accessed via screens 900A, 900B, and user interface screen 1200B of a normal rank window may be accessed via screens 800A, 800B. Various user interface screens as shown in FIG. 5 may be described in more detail with reference to FIGS. 6-15.

FIG. 6 illustrates one embodiment of a first user interface screen. FIG. 6 illustrates a user interface screen 600. User interface screen 600 may provide an example of a GUI display screen generated by user interface module 312 of VLT module 320. As shown in FIG. 6, user interface screen 600 may display a starting window with buttons that allow a user to select a homework mode button 602, a study mode button 604, an option mode button 606, a help mode button 608, and an exit mode button 610. The direction keys 406-1, 406-3 of remote control unit 400 may be used for moving the cursor in a vertical up direction or vertical down direction, respectively, in order to change the focus overlapping the disabled buttons as indicated by lighter shading. Enter key 408 may be used to confirm a selection, option or choice.

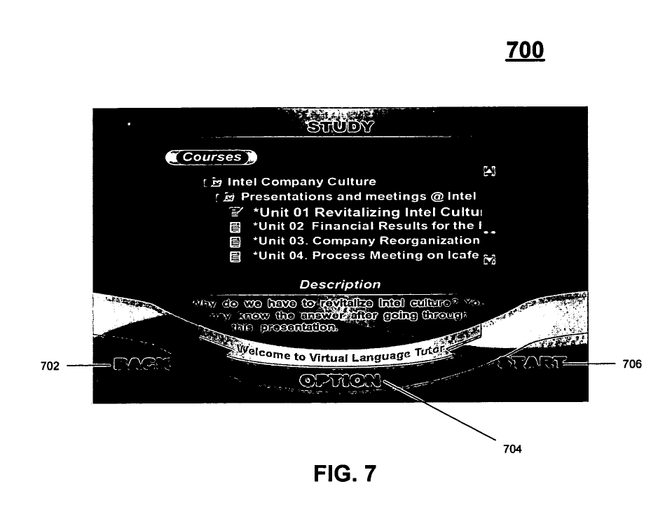

FIG. 7 illustrates one embodiment of a second user interface screen. FIG. 7 illustrates a user interface screen 700A. User interface screen 700A may provide an example of a GUI display screen generated by user interface module 312 of VLT module 320. As shown in FIG. 7, user interface screen 700A may display a study window. In normal mode, the study window is used to choose between various courses. A brief description of each course is displayed at the bottom of the window as the course is highlighted. In homework mode, the study window is used to select assignments to be completed. A brief description of each assignment will appear at the bottom of the study window as it is highlighted.

In operation, direction keys 406-2, 406-4 of remote control unit 400 may be used for moving the cursor in a horizontal left direction or horizontal right direction, respectively, in order to change the focus among the buttons and the panel. Enter key 408 may be used to confirm a selection and open a folder. A back button 702 may be selected and confirmed with enter key 408. Alternatively, escape key 402 may move back to a previous window. An option button 704 may be selected to move to an options window, and a start button 706 may be selected to move to the start window.

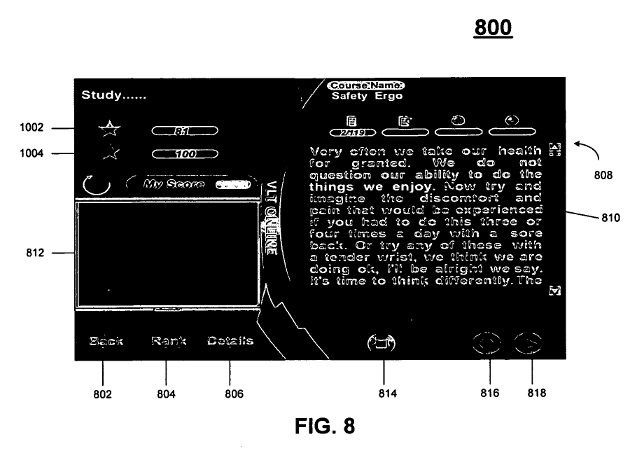

FIG. 8 illustrates one embodiment of a third user interface screen. FIG. 8 illustrates a user interface screen 800A. User interface screen 800A may provide an example of a GUI display screen generated by user interface module 312 of VLT module 320. As shown in FIG. 8, user interface screen 800A may display a study normal window in a normal mode with a video player window 812. Users can practice course and complete assignments in the study normal window.

In operation, direction keys 406-1, 406-3 of remote control unit 400 may be used to change the focus among back button 802, a rank button 804 and a details button 806. Back button 802 may move to a previous screen, rank button 804 may switch to a rank window to display ranking information, and details button 806 may switch to a details window to provide more detailed feedback information for the user. Enter key 408 may be used to confirm a selection. Direction keys 406-1, 406-3 may also be used to choose from different sentences within a content panel 808. Content panel 808 may display language content 810 (e.g., text for a given language). Direction keys 406-1, 406-3 may be used to highlight a sentence of language content 810 within content panel 808. Back button 802 may be used to move back to the homework window or study window 700A, as confirmed by enter button 408. Escape key 402 may also be used to move back to a previous screen. In addition, content key 420 may be used to view or hide the language content 810 in content panel 808, record key 414 or record key 816 may be used to start/stop recording voice information (e.g., user voice or speech) in the main window, play benchmark key 412 or play benchmark button 818 may be used to start/stop playing benchmark voice information in the main window, and play voice key 416 may be used to start/stop playing voice information recorded by a user in the main window. A stop button 814 may be used to stop various operations, such as playing voice information recorded by the user.

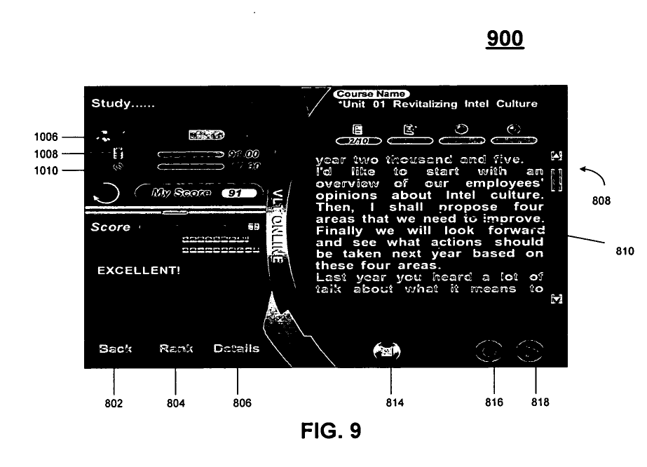

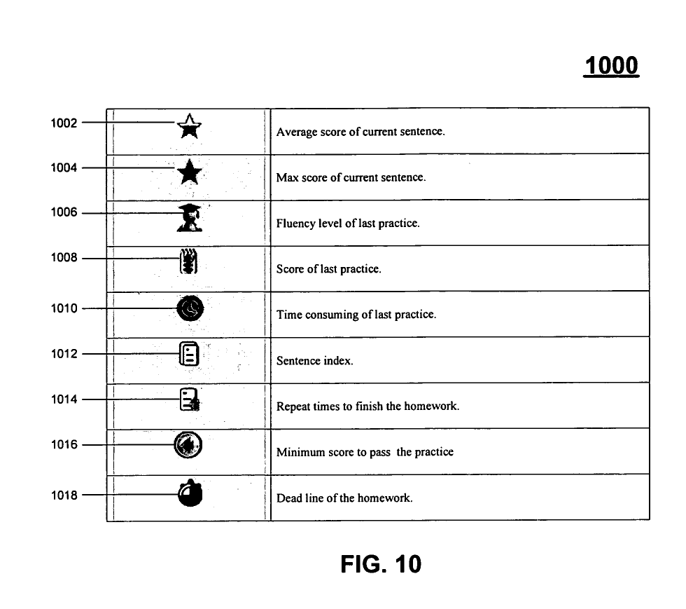

FIG. 9 illustrates one embodiment of a fourth user interface screen. FIG. 9 illustrates a user interface screen 900A. User interface screen 900A may provide an example of a GUI display screen generated by user interface module 312 of VLT module 320. As shown in FIG. 9, user interface screen 900A may display a study window similar to user interface screen 800, but instead of a normal mode the study window is in a competition mode that omits video player window 812 and uses the additional display area to display various user interface elements in the form of icons or symbols. The user interface elements may provide quick visual feedback information to the user. Some examples of user interface elements may be illustrated and described with reference to FIG. 10.

FIG. 10 illustrates one embodiment of user interface elements. FIG. 10 illustrates a list 1000 of user interface elements suitable for use by user interface module 312 of VLT module 320. As shown in FIG. 10, list 1000 may include a user interface element 1002 representing an average score for a current sentence, a user interface element 1004 representing a maximum score of a current sentence, a user interface element 1006 representing a fluency level of a last practice, a user interface element 1008 representing a score for the last practice, a user interface element 1010 representing a time consumed in the last practice, a user interface element 1012 representing a sentence index, a user interface element 1014 representing repeat times to finish the homework, a user interface element 1016 representing a minimum score to pass the practice, and a user interface element 1018 representing a dead line for the homework. With reference to FIGS. 8 and 9, for example, user interface screen 800A includes user interface elements 1002, 1004 positioned above video display window 812, and user interface screen 900A includes user interface elements 1006, 1008 and 1010 similarly positioned. Other user interface elements may be used as well.

It is worthy to note that user interface screens 700B, 800B and 900B illustrating various homework windows are similar to respective interface screens 700A, 800A and 900A illustrating various study windows. Therefore expanded or more detailed versions of user interface screens 700B, 800B and 900B have not been included in an effort to reduce redundancy and increase clarity.

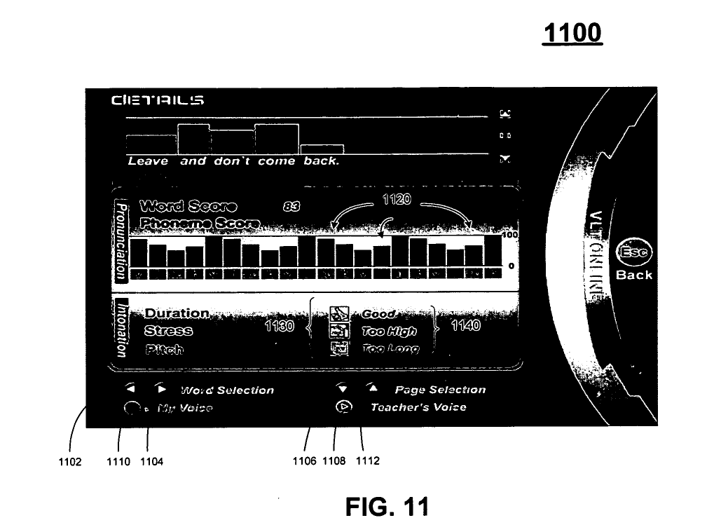

FIG. 11 illustrates one embodiment of a fifth user interface screen. FIG. 11 illustrates a user interface screen 1100. User interface screen 1100 may provide an example of a GUI display screen generated by user interface module 312 of VLT module 320. As shown in FIG. 11, user interface screen 1100 may display a details window having a detailed analysis of the user's most recent speech, with word by word and phoneme by phoneme analysis and feedback information.

User interface screen 1100 may illustrate various types of feedback information. Speech evaluation engine 308 may analyze pronunciation of a word in voice information recorded by a user, and provide feedback information for the pronunciation. For example, the pronunciation feedback information may include a word score and/or a phoneme score. The voice information provided by a user may be compared to benchmark voice information. The comparison results may be quantified and scored. Graphic bars 120 may be used to provide a visual indication as to how well a given letter or letter combination was pronounced. Similarly, speech evaluation engine 308 may analyze intonation of a word in the voice information recorded by a user, and provide feedback information for the intonation. For example, the intonation feedback information may include a duration value, a stress value and/or a pitch value. User interface elements 1130 in the form of symbols or icons may be used to indicate intonation performance, with each user interface element 1130 having corresponding user interface elements 1140 in the form of text.

In operation, direction keys 406-2, 406-4 or direction buttons 1102, 1104 may be used to choose different words. Direction keys 406-1, 406-3 may be used to page up or page down, respectively. Direction buttons 1106, 1108 may also be used to page up or page down, respectively, as well. Escape key 402 may be used to move back to the main window. Play voice key 416 or play voice button 1110 may be used to start/stop playing voice information for a user. Play benchmark key 412 or play benchmark button 1112 may be used to start/stop playing the benchmark voice information.

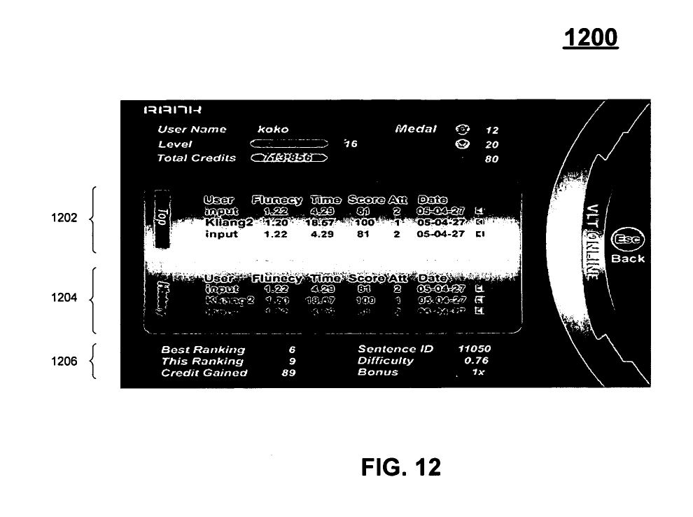

FIG. 12 illustrates one embodiment of a sixth user interface screen. FIG. 12 illustrates a user interface screen 1200. User interface screen 1200 may provide an example of a GUI display screen generated by user interface module 312 of VLT module 320. As shown in FIG. 12, user interface screen 1200 may display a rank window to display high score information for the current sentence, as well as the user's cumulative credits and medals. For example, a top score section 1202 may be displayed with user ranking results including a user name, a fluency rating, a time rating, a test score, an attribute value, a date, and so forth. In another example, a history section 1204 may be displayed with historical information for similar categories. User interface screen 1200 may also include user interface elements 1206 indicating such performance metrics as best ranking, this ranking, credit gained, sentence identifier, difficulty level, and bonus scores. The ranking values may represent a student's ranking with respect to previous attempts or with respect to other students. For example, the ranking values may represent the student's ranking for the last attempt at the sentence, the best ranking for any attempt by the student at the sentence and an amount of course credit for the student's effort. A credit bar may be used to track overall progress through a course of study and shows the total credit earned.

In operation, direction keys 406-1, 406-3 may be used to choose different rows. Enter key 408 may be used to play a selected audio file. Escape key 402 may be used to exit back to the main window.

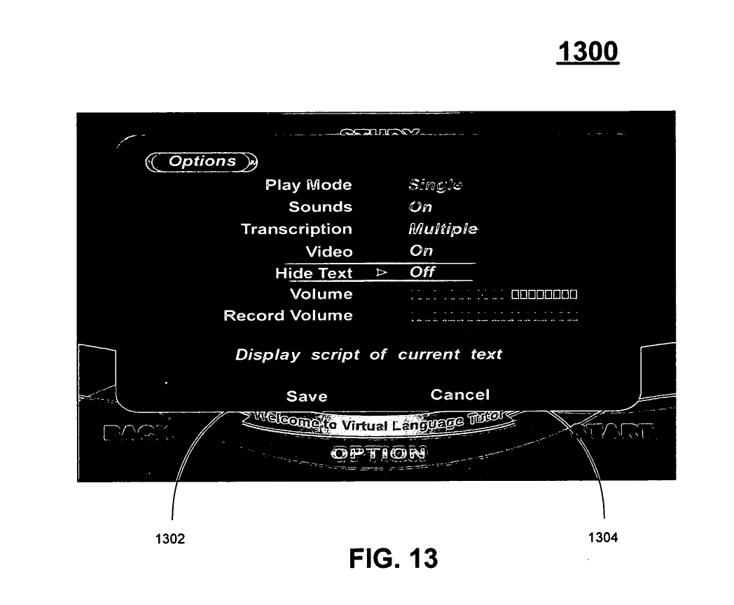

FIG. 13 illustrates one embodiment of a seventh user interface screen. FIG. 13 illustrates a user interface screen 1300. User interface screen 1300 may provide an example of a GUI display screen generated by user interface module 312 of VLT module 320. As shown in FIG. 13, user interface screen 1300 may display an option window overlaid or superimposed with the current user interface screen. The option window allows the user to change settings for various parameters of VLT module 320. Examples of parameters may include a play mode, sounds, transcription, video, hide text, volume and record volume. In operation, direction keys 406-1, 406-3 may be used to scroll between the various options. There are three ways to close the option window. The first way is to select a save button 1302 and use enter key 408 to confirm the selection. If save button 1302 is selected and confirmed, VLT module 320 will save the changes for the parameters and close the window. The second way is to select a cancel button 1104 and use enter key 408 to confirm the selection. If cancel button 1304 is selected and confirmed, VLT module 320 will not save the changes for the parameters and close the window. The third way is to depress escape button 402 to close the window, in which case VLT module 320 will not save any changes for the parameters.

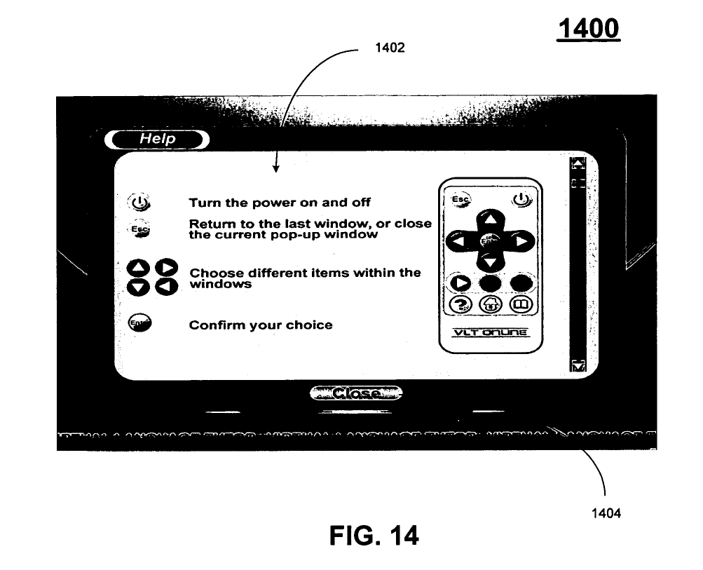

FIG. 14 illustrates one embodiment of an eighth user interface screen. FIG. 14 illustrates a user interface screen 1400. User interface screen 1400 may provide an example of a GUI display screen generated by user interface module 312 of VLT module 320. As shown in FIG. 14, user interface screen 1400 may display a help window to show help information for the various functions and usage of VLT module 320. For example, the help window may provide a graphic for remote control unit 400 with the input keys and corresponding functions. In operation, direction buttons 406-2, 406-4 may be used to between a help content panel 1402 and a close button 1404. Direction buttons 406-1, 406-3 may be used to scroll through the help information displayed by help content panel 1402. The help window may be closed by selecting close button 1404 and depressing enter key 408 to confirm the selection, or depressing escape key 402.

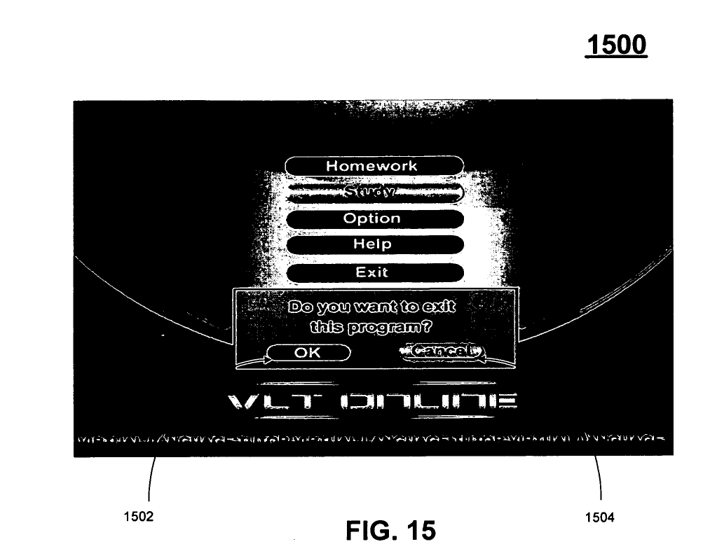

FIG. 15 illustrates one embodiment of a ninth user interface screen. FIG. 15 illustrates a user interface screen 1500. User interface screen 1500 may provide an example of a GUI display screen generated by user interface module 312 of VLT module 320. As shown in FIG. 15, user interface screen 1500 may display an exit message window to quit or exit the system. In operation, direction keys 406-2, 406-4 may be used to scroll between an OK button 1502 and a cancel button 1504, and enter key 408 may be used to confirm a selection.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

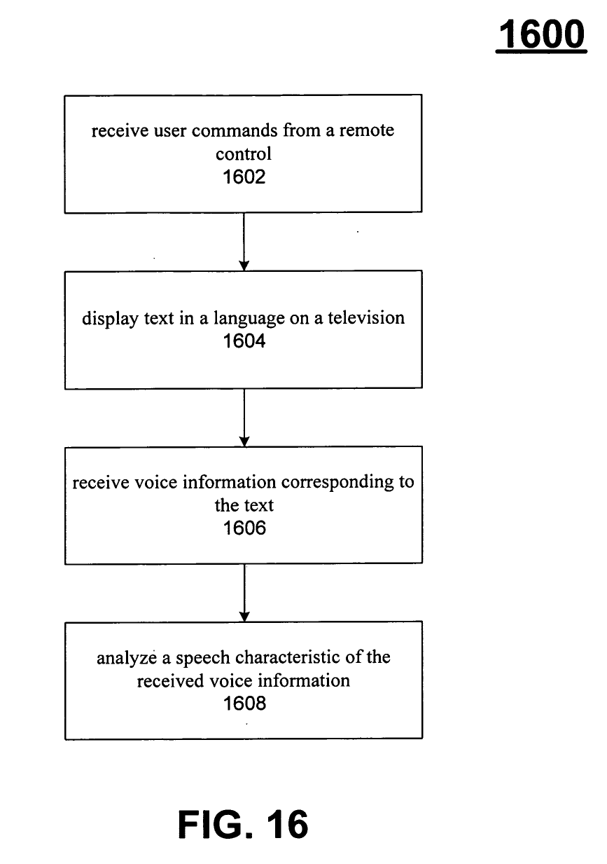

FIG. 16 illustrates one embodiment of a logic flow. FIG. 16 illustrates a logic flow 1600. Logic flow 1600 may be representative of the operations executed by one or more embodiments described herein, such as media processing node 106, media processing sub-system 108, ILPM 208, and/or VLT module 320. As shown in logic flow 1600, logic flow 1600 receives user commands from a remote control at block 1602. Logic flow 1600 displays text in a language on a television at block 1604. Logic flow 1600 receives voice information corresponding to the text at block 1606. Logic flow 1600 analyzes a speech characteristic of the received voice information at block 1608. The embodiments are not limited in this context.

In various embodiments, media processing system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the IEEE, the Internet Engineering Task Force (IETF), the Motion Picture Experts Group (MPEG), and so forth. For example, the described embodiments may be arranged to operate in accordance with standards for media processing, such as the National Television Systems Committee (NTSC) standard, the Advanced Television Systems Committee (ATSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the DVB Satellite (DVB-S) broadcasting standard, the DVB Cable (DVB-C) broadcasting standard, the Open Cable standard, the Society of Motion Picture and Television Engineers (SMPTE) Video-Codec (VC-1) standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of media processing system 100 may be arranged to communicate, manage or process different types of information, such as media information and control information. Examples of media information may generally include any data or signals representing content meant for a user, such as media content, voice information, video information, audio information, image information, textual information, numerical information, alphanumeric symbols, graphics, and so forth. Control information may refer to any data or signals representing commands, instructions or control words meant for an automated system. For example, control information may be used to route media information through a system, to establish a connection between devices, instruct a node to process the media information in a predetermined manner, monitor or communicate status, perform synchronization, and so forth. The embodiments are not limited in this context.

In various embodiments, media processing system 100 may be implemented as a wired communication system, a wireless communication system, or a combination of both. Although media processing system 100 may be illustrated using a particular communications media by way of example, it may be appreciated that the principles and techniques discussed herein may be implemented using any type of communication media and accompanying technology. The embodiments are not limited in this context.

When implemented as a wired system, for example, media processing system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, media processing system 100 may include one or more wireless nodes arranged to communicate information over one or more types of wireless communication media. An example of wireless communication media may include portions of a wireless spectrum, such as the RF spectrum. The wireless nodes may include components and interfaces suitable for communicating information signals over the designated wireless spectrum, such as one or more antennas, wireless transmitters, receiver, transmitters/receivers (“transceivers”), amplifiers, filters, control logic, antennas, and so forth. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory 406. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a remote control receiver to receive user commands;
a receiver to receive voice information; and
a virtual language tutor module having a user interface module and a speech evaluation engine, said user interface module to respond to said user commands to control said virtual language tutor module, and said speech evaluation engine to analyze a speech characteristic of said voice information and provide feedback information for said speech characteristic.

2. The apparatus of claim 1, comprising a display to display language content, said wireless receiver to receive voice information corresponding to said displayed text.

3. The apparatus of claim 1, said speech evaluation engine to recognize words in said received voice information.

4. The apparatus of claim 1, said speech evaluation engine to analyze pronunciation of a word in said voice information, and provide feedback information for said pronunciation.

5. The apparatus of claim 1, said speech evaluation engine to analyze intonation of a word in said voice information, and provide feedback information for said intonation.

6. The apparatus of claim 1, said interactive language learning device comprising a digital set top box.

7. The apparatus of claim 1, said interactive language learning device comprising a memory unit to store said virtual language tutor module, and a processor coupled to said memory unit to execute said virtual language tutor module.

8. The apparatus of claim 1, comprising a remote control unit having input keys and a remote control transmitter, said input keys to receive said user commands, said remote control transmitter to communicate said user commands to said remote control receiver.

9. The apparatus of claim 1, comprising a wireless headset having a microphone and wireless transmitter, said microphone to receive said voice information, said wireless transmitter to communicate said voice information to said wireless receiver.

10. The apparatus of claim 1, comprising a communication interface to communicate language content for said virtual language tutor module.

11. A method, comprising:
receiving user commands from a remote control;
displaying text in a language on a television;
receiving voice information corresponding to said text; and
analyzing a speech characteristic of said received voice information.

12. The method of claim 11, comprising generating pronunciation results for said voice information including a word score or a phoneme score.

13. The method of claim 11, comprising generating intonation results for said voice information including a duration value, a stress value, or a pitch value.

14. The method of claim 11, comprising generating user ranking results including a user name, a fluency rating, a time rating or a test score.

15. The method of claim 11, comprising parsing said voice information into words, and analyzing a speech characteristic for each word.

16. An article comprising a machine-readable storage medium containing instructions that if executed enable a system to:
receive user commands from a remote control;
display text in a language on a television;
receive voice information corresponding to said text; and
analyze a speech characteristic of said received voice information.

17. The article of claim 16, further comprising instructions that if executed enable the system to generate pronunciation results for said voice information including a word score or a phoneme score.

18. The article of claim 16, further comprising instructions that if executed enable the system to generate intonation results for said voice information including a duration value, a stress value, or a pitch value.

19. The article of claim 16, further comprising instructions that if executed enable the system to generate user ranking results including a user name, a fluency rating, a time rating or a test score.

20. The article of claim 16, further comprising instructions that if executed enable the system to:
parse said voice information into words; and
analyze a speech characteristic for each word.
